(19) United States
(12) Patent Application Publication
(10) Pub. No.: US 2012/0019253 A1
(43) Pub. Date: Jan. 26, 2012

(54) METHOD FOR DETERMINING AN AGING CONDITION OF A BATTERY CELL BY MEANS OF IMPEDANCE SPECTROSCOPY

(76) Inventors: Joerg Ziegler, Rutesheim (DE); Martin Tenzer, Schwieberdingen (DE); Elke Krauss, Gerlingen (DE); Martin Holger Koenigsmann, Stuttgart (DE)

(21) Appl. No.: 13/145,613

(22) PCT Filed: Jan. 14, 2010
(86) PCT No.: PCT/EP2010/050381

§ 371 Date: Jul. 21, 2011

(30) Foreign Application Priority Data
Jan. 21, 2009 (DE) 102009000337.1

(51) Int. Cl. G01N 27/416

(52) U.S. Cl. 324/433

(57) ABSTRACT

The invention relates to a method for determining an aging condition of a battery cell. The method has the following steps of a) providing a battery cell, b) recording an impedance spectrum of the battery cell, c) determining an evaluation quantity based on the measured impedance spectrum, and d) determining an aging condition of the battery cell based on a comparison of the evaluation quantity to a reference value.

### PRIOR ART

In the qualification of battery cells, the aging condition of the cells has to be determined, and possibly a prediction must be made as to the likely lifetime remaining. These indications play a major role, above all in assessing battery cells that have to be newly qualified. Especially in the SOH (State of Health) determination of batteries, and in the operation of battery management systems, for instance in vehicles, a rapid assessment of battery cells with regard to the aging condition and/or lifetime is necessary.

As methods for this, until now there have been measuring the direct current resistance and measuring the cell capacitance. However, these conventional methods provide only inadequate knowledge about the condition of the battery cells tested. Until now, estimating an aging condition of battery cells using these conventional methods could be done only inadequately. Reliably predicting the lifetime of battery cells is therefore impossible.

The object of the present invention is to lessen or overcome one or more disadvantages of the prior art. In particular, it is the object of the invention to furnish a method in which the aging condition and possibly the likely lifetime of a cell can be determined quickly and reliably.

### DISCLOSURE OF THE INVENTION

The object is attained by furnishing a method for determining an aging condition of a battery cell, including the steps of

a) furnishing a battery cell;

b) recording an impedance spectrum of the battery cell;

c) ascertaining an evaluation variable on the basis of the measured impedance spectrum;

d) determining an aging condition of the battery cell on the basis of a comparison of the evaluation variable with a reference value.

Depending on the aging condition of a battery cell, characteristic changes in the impedance spectrum of the battery cell occur. These characteristic changes can be ascertained by comparing an evaluation variable, which is ascertained on the basis of the measured impedance spectrum for the applicable battery cell, with a corresponding reference variable. If the comparison of an evaluation variable with a corresponding reference value shows a deviation, or even no deviation, from the reference value, then an aging condition can be assigned to the applicable battery cell. For instance, if the impedance of a battery cell in a low-frequency range is elevated compared to a reference value, then the aging condition of the battery cell is poorer than that of a battery cell of which the corresponding impedance value does not exceed the reference value. The worsening of an aging condition of a battery cell is correlated with the extent of deviation between the evaluation variable and the reference value. If the deviation is greater, the aging condition of the battery cell is poorer. If the deviation is less, the aging condition of the battery cell is better.

In the method of the invention, a battery cell is furnished whose aging condition is to be determined. Battery cells of all the usual rechargeable battery technologies can be employed. Battery cells of the following types can be used: lead battery, NiCd or nickel-cadmium battery, NiH2 or nickel-hydrogen battery, NiMH or nickel-metal hydride battery, Li-ion or lithium-ion battery, LiPo or lithium-polymer battery, LiFe or lithium-metal battery, LiMn or lithium-manganese battery, LiFePO₄ or lithium-iron phosphate battery, LiTi or lithium titanate battery, RAM or rechargeable alkaline manganese battery, NiFe or nickel-iron battery, Na/NiCl or sodium-nickel chloride high-temperature battery, SCiB or Super Charge Ion battery, silver-zinc battery, silicone battery, vanadium-redox battery, and/or zinc-bromium battery. In particular, battery cells of the lead/acid, nickle-cadmium, nickel-metal hydride, and/or sodium/sodium nickel chloride cell can be used. Especially preferably, battery cells of the lithium-ion cell type are employed.

In the method of the invention, an impedance spectrum of the battery cell is recorded. In the process, the battery cell is excited via its contacts by a sinusoidal signal of variable frequency, and by measuring the current and voltage, the complex impedance of the battery cell is ascertained as a function of the frequency. The measured impedance spectrum can be displayed in various forms, for instance as a Nyquist plot, in which imaginary impedance values are plotted over real impedance values, or as a Bode graph, in which measured impedance values are represented as a function of the frequency. In the method of the invention, the impedance spectrum can be recorded over a frequency range ≦100 Hz, ≦10 Hz, ≦1 Hz, or from 100 to 0.001 Hz, preferably over a frequency range of from 10 to 0.001 Hz, and especially preferably over a range of from 1 to 0.01 Hz or 0.1 to 0.03 Hz. An impedance spectrum can also comprise a single impedance value at a single selected frequency.

The recording of the impedance spectrum can be done at a low temperature. A low temperature prevails whenever the temperature is below the optimum operating temperature of the battery cell to be measured. Preferably, the impedance spectrum of the battery cell is recorded at a temperature that is 5 room temperature, ≦15° C., ≦10° C., or ≦5° C.

In the method of the invention, an evaluation variable is ascertained on the basis of the measured impedance spectrum. This evaluation variable can be determined by means of a graphic evaluation of the measured impedance spectrum, for instance via a Nyquist plot and/or a Bode graph. The evaluation variable can also be determined by way of a mathematical calculation from the data of the measured spectrum.

As the evaluation variable, various values that can be ascertained from the measured impedance spectrum can be used. Values that can be considered for the evaluation variable are those of which the deviation from a reference value allows a statement to be made about an aging condition of the battery cell. In particular, an increase in impedance in the low-frequency range as well as the embodiment of a further RC-network in the impedance spectrum correlate with an advancing aging condition of the battery cell. The extent of the deviation in these two variables correlates with the extent of the change in the aging condition. Thus in particular, those values which are suitable for determining an increase in impedance in the low-frequency range, or which are suitable for identifying a further RC-network in the impedance spectrum, can be used as the evaluation variable.

The following evaluation variables are suitable for determining an increase in impedance in the low-frequency range.

The evaluation variable can be a real impedance value in Ohms, which was measured at a defined low frequency. As the low frequency, any frequency can be used which is ≦10 Hz, and preferably ≦1 Hz. Preferably, the low frequency can be selected from the range of from 10-0.001 Hz, and especially preferably from the range of from 1-0.01 Hz, and very particularly preferably from the range of from 0.1-0.03 Hz. In that case, the reference value is a real number having Ohms as a unit.

The evaluation variable can indicate a ratio of a real impedance value in Ohms, which was measured at a first low frequency, to a real impedance value in Ohms, which was measured at a second low frequency. As the low frequency, any frequency can be used which is ≦10 Hz, and preferably ≦1 Hz. Preferably, the low frequency can be selected from the range of from 10-0.001 Hz, and especially preferably from the range of from 1-0.01 Hz, and very particularly preferably from the range of from 0.1-0.03 Hz.

The ratio can be formed in such a way that the first low frequency has a lesser frequency value than the second low frequency. It is also possible to form the ratio such that the first low frequency has a higher frequency value than the second low frequency.

The ratio can be expressed this way:

A=Z_{N1}/Z_{N2}

in which A is the evaluation variable, Z_{N1} is a measured impedance value of the battery cell at a first low frequency N1, and Z_{N2} is a measured impedance value of the battery cell at a second low frequency N2, where N1≠N2, and preferably N1<N2.

If the evaluation variable is indicated as a ratio of absolute impedance values to one another, then the reference value is a real number without a unit. Preferably, the reference value is ≧1.10, and especially preferably ≧1.15.

The evaluation variable can also be indicated as a real low-frequency value in Hz, at which a defined threshold impedance value in Ohms is reached or exceeded. In the recorded impedance spectrum of the battery cell, the low-frequency value at which a defined threshold impedance value is reached or exceeded is determined. The lowest frequency value of an impedance spectrum at which the threshold impedance value is reached or just barely exceeded is called the low-frequency value. As the threshold impedance value, an impedance value can be selected that is between a minimum impedance and a maximum impedance in the low-frequency range.

Preferably, the threshold impedance value can be defined for each type of battery cell and is in a range which does not exceed 90% of the maximum impedance in the low-frequency range, and especially preferably does not exceed 80%. The maximum impedance in the low-frequency range can be determined for each type of battery cell by forming an average value of maximum impedances in the low-frequency range of a plurality of battery cells of the same type, and in the impedance measurement of the particular battery cell of the same type, no more than 10% of the average lifetime of the battery cells of the same type has elapsed. In a particular embodiment, the threshold impedance value is selected from the range of from 0.07 to 0.1 Ohms, and a threshold impedance value of 0.07 or 0.08 Ohms is especially preferred.

If the evaluation variable is a low-frequency value at which a threshold impedance value is reached or has just barely been exceeded, then the reference value is a real number having Hz as the unit.

The following evaluation variables are suitable for identifying a further RC-network in the impedance spectrum.

The evaluation variable can be the number of semicircular arcs of an impedance spectrum in the Nyquist plot.

The evaluation variable can be the number of turning points of an impedance spectrum in the Nyquist plot.

The evaluation variable can also be the number of RC-networks in an impedance spectrum.

If the evaluation variable is the number of semicircular arcs or the number of turning points of an impedance spectrum in the Nyquist plot or the number of RC-networks of an impedance spectrum, then the reference value is a real number without a unit.

For determining an aging condition of the battery cell, the evaluation variable is compared with a corresponding reference value. On the basis of the defined deviation of the evaluation variable and reference value, a statement can then be made about the aging condition of the battery cell. The reference value represents the comparison variable with which the evaluation variable is compared. The reference value is the variable corresponding to the evaluation variable, and the aging condition of the battery cell that is used for ascertaining the reference value is known. For instance, if the evaluation variable is a measured impedance value at a defined low frequency of a battery cell whose aging condition is to be determined, then the corresponding reference value is a defined impedance value at the same low frequency, determined for one or more reference battery cells with a known aging condition. If the evaluation variable is a number of RC-networks in a measured impedance spectrum, then the corresponding reference value is the number of RC-networks, determined for one or more reference battery cells with a known aging condition.

If the evaluation variable exceeds the reference value, then the aging condition of the analyzed battery cell is poorer than the aging condition of the battery cell or cells of the reference value. If the evaluation variable is below the reference value, then the aging condition of the analyzed battery cell is better than the aging condition of the battery cell or cells of the reference value. The actual value which is made the basis as a reference value in determining an aging condition of a battery cell also depends on the particular type of battery cell and can vary from one type of battery cell to another. This situation is familiar to one skilled in the art, who has no difficulties in ascertaining a suitable reference value for a given type of battery cell.

As an example, two methods for determining a reference value will be given.

For instance, the reference value can be determined on the basis of an impedance spectroscopy measurement of the cell to be analyzed from step a); this reference impedance spectroscopy measurement is performed chronologically before the recording of an impedance spectrum in step b) of the method of the invention. Preferably, the reference impedance spectroscopy measurement is done at a time at which less than 10% of the average lifetime of battery cells of the same type has elapsed. Especially preferably, the reference impedance spectroscopy measurement is done before the battery cell to be measured is first used as an energy source.

The reference value can also be determined by forming an average value from corresponding values which are determined for a plurality of reference battery cells of the same type as the battery cell of step a) to be analyzed. Which have a defined, known aging condition. The corresponding values are each ascertained on the basis of a reference impedance spectroscopy measurement of the individual reference battery cells of the same type and of the defined, known aging condition, and an average value is then formed from them. The particular reference impedance spectroscopy measurement of reference battery cells of the same type can preferably be done at a time at which less than 10% of the average lifetime of the reference battery cells has elapsed. In the method of the invention, a reference value can be determined by forming an average value from corresponding values that are determined for one or a plurality of reference battery cells of the same type as the battery cell of step a), and the corresponding values are each ascertained on the basis of a reference impedance spectroscopy measurement of the individual reference battery cell, and the reference battery cells of a reference value have a defined, known aging condition.

By setting up a series of reference values for reference battery cells of a different, known aging condition, not only can the aging condition of a battery cell to be analyzed of the same type be determined. Precise predictions can also be made about the lifetime still remaining for the battery cell to be analyzed. The accuracy of the prediction depends essentially on the density of the reference values of a known aging condition. For instance, if the reference values for reference battery cells of the same type, spaced apart in terms of aging by 50 days, beginning with the new reference battery cell and extending through to the completely exhausted reference battery cell, are known, then a prediction can be made about the remaining residual lifetime of a battery cell of the same type to be determined with an accuracy of ±50 days.

The invention also relates to the use of an impedance spectrum of a battery cell for determining an aging condition of a rechargeable battery that includes this battery cell.

The invention also relates to a use of the method of the invention for predicting a lifetime of a battery cell or of a rechargeable battery.

The method of the invention can be employed for fast cell assessment of battery cells that are newly to be qualified, and also for determining the aging condition of battery cells. By the method of the invention, economies in terms of test times and possibly test cycles can be made, since relevant information can already be obtained at an earlier time. The method of the invention can be employed in hybrid (HEV) and electric (EV) vehicles for SOH (State Of Health) determination and as part of a battery management system.

By employing impedance spectroscopic methods, the aging condition and the likely lifetime of individual battery cells and thus of a rechargeable battery can be determined faster and markedly more precisely than with the previously customary methods. In particular, practically no useful prediction can be made about the lifetime of the cell from the usual measurements of capacitance and direct current resistance over time. Moreover, the corresponding impedance spectra can be assessed simply and without major effort or expense. In addition, impedance spectroscopy in a measurement can also provide further data that can provide information about the causes of the aging. For instance, from the frequency range of the change in impedance, conclusions can be drawn as to which part of the cell changes have occurred in. The method can be used in principle in all customary rechargeable battery technologies, such as lead-acid, nickel-cadmium, nickel-metal hydride, and sodium-sodium nickel chloride (Zebra), and especially preferably in lithium-ion rechargeable batteries.

### DRAWINGS

FIG. 1a: impedance spectra of the lithium-ion battery cell 102 in the Nyquist plot, aged at +60° C.

FIG. 1b: impedance spectra of the lithium-ion battery cell 103 in the Nyquist plot, aged at +60° C.

FIG. 2a: impedance spectra of the lithium-ion battery cell 102 in the Bode graph, aged at +60° C.

FIG. 2b: impedance spectra of the lithium-ion battery cell 103 in the Bode graph, aged at +60° C.

### DESCRIPTION OF EXEMPLARY EMBODIMENTS

According to the invention, the determination of the aging condition and the prediction of the lifetime are done by impedance spectroscopy. It can be shown here that the aging of the cells makes itself perceptible primarily by two signs, here illustrated as examples in one of our series of measurements using lithium-ion rechargeable batteries:

1) Impedance Increase in the Low-Frequency Range

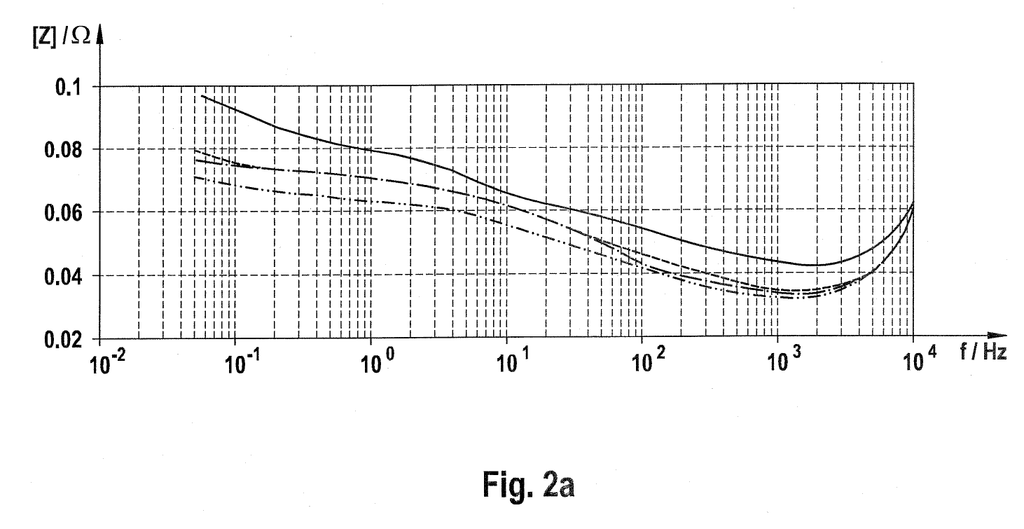

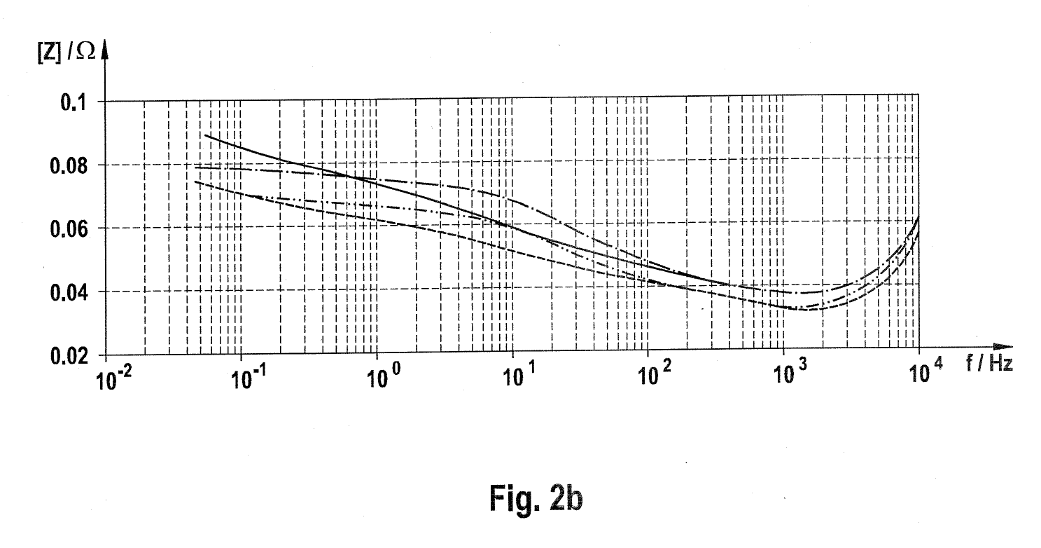

An increasing aging condition in these cells is exhibited by an increase in the impedance, above all in the low-frequency range (see FIG. 2). The increase in impedance is essentially independent of the length of aging; instead, it is dependent on all relevant factors that contribute to the aging, including among others SOC (State Of Charge) and temperature. Thus the increase in impedance can be used for quantifying the aging condition and in particular for predicting the lifetime.

2) Embodiment of a Second RC-Network in the Impedance Spectrum

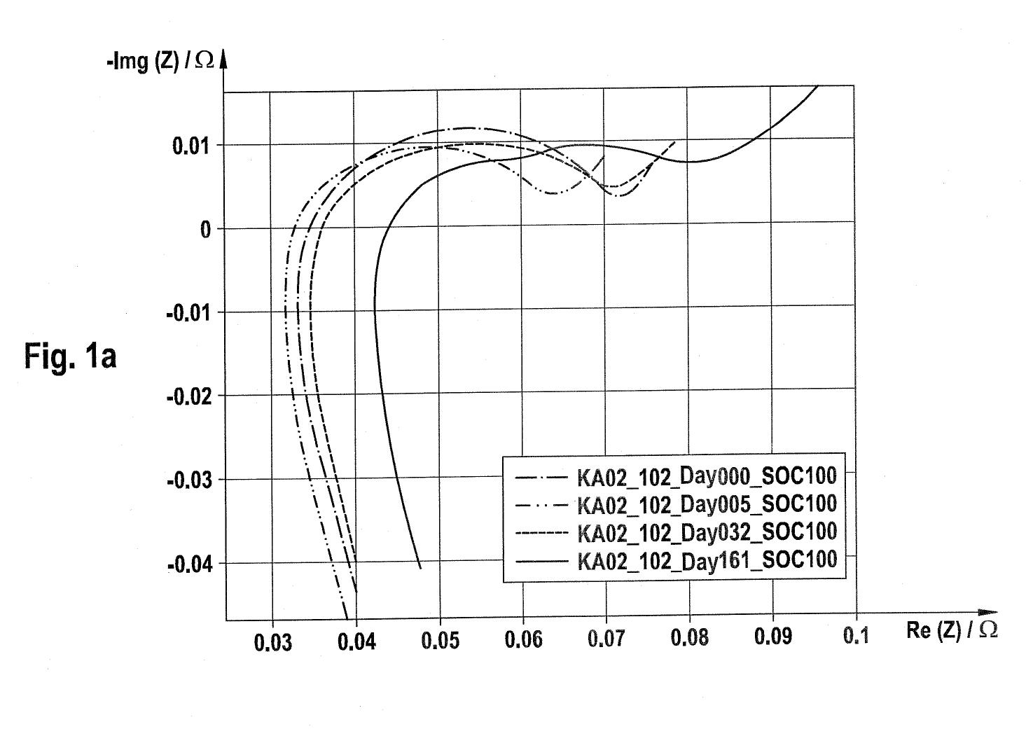

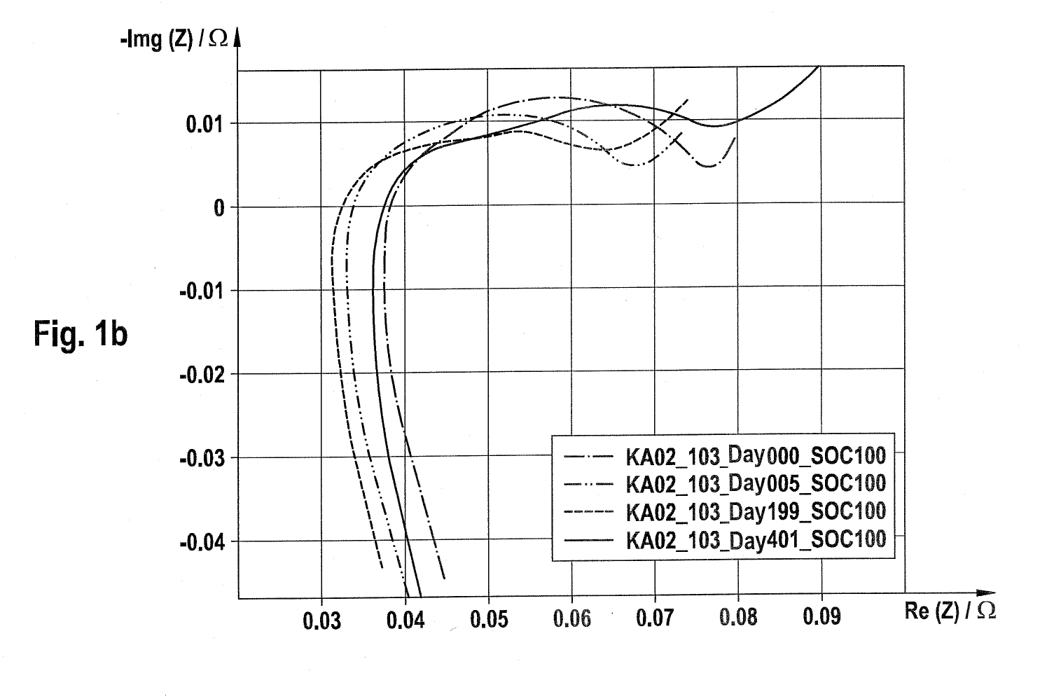

Besides the increase in impedance in the low-frequency range, over the course of cell aging, the successive development of a second RC-network in the spectrum is also observed in these cells (see FIG. 1). There is a smooth transition from only one to two RC-networks in the spectrum, represented by semicircular arcs in the Nyquist plot. It is shown that the degree of development of the second semicircular arc correlates with the chronological aging. Moreover, a degree of the development of the second semicircular arc is also associated with the immediately imminent end of the lifetime. Thus already at the beginning of the development of the second arc, a conclusion about the end of the lifetime can be drawn, which makes a reliable prediction of the lifetime possible sooner.

The effects described here in impedance measurements are even more clearly apparent at low temperatures. Moreover, the beginning of the low-frequency increase in impedance can also be detected earlier, if the measurements are extended to even lower frequencies.

In FIGS. 1a and 1b, the impedance spectra of two cells are shown, each in the Nyquist plot. While cell 102 (FIG. 1a) has already reached the end of its lifetime after 161 days, for cell 103 (FIG. 1b) this does not happen until after 401 days. Nevertheless, in both cells, the significant development of a second RC-network in the spectrum is seen toward the end of their lifetime.

In FIGS. 2a and 2b, the impedance spectra of the same two cells are shown as Bode illustrations (for captions, see FIGS. 1a and 1b, respectively). It can be seen clearly that toward the end of the lifetime of the cells, a significant increase in the impedance in the low-frequency range becomes visible. This increase is already indicated at earlier times by the fact that the impedance curve on the left end of the frequency range is beginning to curve upward.

1-10. (canceled)

11. A method for determining an aging condition of a battery cell, including the steps of:
a) furnishing a battery cell;
b) recording an impedance spectrum of the battery cell;
c) ascertaining an evaluation variable based on a measured impedance spectrum; and
d) determining an aging condition of the battery cell based on a comparison of the evaluation variable with a reference value.

12. The method as defined by claim 11, wherein the evaluation variable is a measured impedance value in Ohms at a defined low frequency, and the reference value is a real number having Ohms as a measurement unit.

13. The method as defined by claim 11, wherein the evaluation variable indicates a ratio of a measured impedance value at a first low frequency to a measured impedance value at a second low frequency, and the reference value is a defined real number.

14. The method as defined by claim 13, wherein the first low frequency has a value less than a value of the second low frequency.

15. The method as defined by claim 11, wherein the evaluation variable is a low frequency in Hz, at which a defined threshold impedance value in Ohms is reached or exceeded, and the reference value is a real number having Hz as the unit.

16. The method as defined by claim 11, wherein the evaluation variable is a number of RC-networks in the measured impedance spectrum of the battery cell, and the reference value is a real number without a unit.

17. The method as defined by claim 11, wherein the reference value is determined based on a reference impedance spectroscopy measurement of the battery cell from step a), and this reference impedance spectroscopy measurement is performed chronologically before the recording of an impedance spectrum in accordance with step b).

18. The method as defined by claim 12, wherein the reference value is determined based on a reference impedance spectroscopy measurement of the battery cell from step a), and this reference impedance spectroscopy measurement is performed chronologically before the recording of an impedance spectrum in accordance with step b).

19. The method as defined by claim 13, wherein the reference value is determined based on a reference impedance spectroscopy measurement of the battery cell from step a), and this reference impedance spectroscopy measurement is performed chronologically before the recording of an impedance spectrum in accordance with step b).

20. The method as defined by claim 15, wherein the reference value is determined based on a reference impedance spectroscopy measurement of the battery cell from step a), and this reference impedance spectroscopy measurement is performed chronologically before the recording of an impedance spectrum in accordance with step b).

21. The method as defined by claim 16, wherein the reference value is determined based on a reference impedance spectroscopy measurement of the battery cell from step a), and this reference impedance spectroscopy measurement is performed chronologically before the recording of an impedance spectrum in accordance with step b).

22. The method as defined by claim 11, wherein the reference value is determined by forming an average value of corresponding values which are determined for one or a plurality of reference battery cells of a same type as the battery cell of step a), and the corresponding values are each ascertained based on a reference impedance spectroscopy measurement of the individual reference battery cell, and the plurality of reference battery cells of a reference value have a defined, known aging condition.

23. The method as defined by claim 12, wherein the reference value is determined by forming an average value of corresponding values which are determined for one or a plurality of reference battery cells of a same type as the battery cell of step a), and the corresponding values are each ascertained based on a reference impedance spectroscopy measurement of the individual reference battery cell, and the plurality of reference battery cells of a reference value have a defined, known aging condition.

24. The method as defined by claim 13, wherein the reference value is determined by forming an average value of corresponding values which are determined for one or a plurality of reference battery cells of a same type as the battery cell of step a), and the corresponding values are each ascertained based on a reference impedance spectroscopy measurement of the individual reference battery cell, and the plurality of reference battery cells of a reference value have a defined, known aging condition.

25. The method as defined by claim 15, wherein the reference value is determined by forming an average value of corresponding values which are determined for one or a plurality of reference battery cells of a same type as the battery cell of step a), and the corresponding values are each ascertained based on a reference impedance spectroscopy measurement of the individual reference battery cell, and the plurality of reference battery cells of a reference value have a defined, known aging condition.

26. The method as defined by claim 16, wherein the reference value is determined by forming an average value of corresponding values which are determined for one or a plurality of reference battery cells of a same type as the battery cell of step a), and the corresponding values are each ascertained based on a reference impedance spectroscopy measurement of the individual reference battery cell, and the plurality of reference battery cells of a reference value have a defined, known aging condition.

27. The use of a method as defined by claim 11 for predicting a lifetime of a battery cell or of a rechargeable battery.

28. The use of a method as defined by claim 17 for predicting a lifetime of a battery cell or of a rechargeable battery.

29. The use of a method as defined by claim 22 for predicting a lifetime of a battery cell or of a rechargeable battery.

30. A use of an impedance spectrum of a battery cell for determining an aging condition of a rechargeable battery which includes the battery cell.
